(19) United States
(12) Patent Application Publication
(10) Pub. No.: US 2009/0121972 A1
(43) Pub. Date: May 14, 2009

(54) CRT display having a single plane sheath beam bender and video correction

(76) Inventor: Richard Hugh Miller, Ephrata, PA (US)

Correspondence Address: Robert D. Shedd;Thomson Licensing LLC, PO Box 5312, PRINCETON, NJ, 08543-5312, US

(21) Appl. No.: 11/990,570

(22) PCT Filed: Feb. 27, 2006
(86) PCT No.: PCT/US2006/006703

§ 371 Date: Feb. 14, 2008

Related U.S. Application Data
(60) Provisional application No. 60/713,142, filed on Aug. 31, 2005.

(51) Int. Cl. G09G 1/06; H01J 29/56

(52) U.S. Cl. 345/11; 315/370

(57) ABSTRACT

There are provided CRT display systems. A CRT display system includes an electron gun assembly, a single plane sheath beam bender, and a digital processor. The electron gun assembly is configured to emit electron beams. The single plane sheath beam bender is configured to apply a deflection force to the electron beams. The digital processor is configured to receive and process an incoming video signal stream to provide signals there from to be delivered to individual cathodes of the electron gun assembly. The provided signals have a distortion applied thereto to effect a predetermined converged image. The applied distortion at least relates to a blue-bow convergence error.

### CROSS-REFERENCE TO RELATED APPLICATIONS

This is a non-provisional application claiming the benefit of provisional application Ser. No. U.S. 60/713,142, entitled “A VERTICAL SCAN HDTV CRT DISPLAY HAVING A SINGLE PLANE SHEATH BEAM BENDER AND VIDEO CORRECTION”, filed on Aug. 31, 2005, and incorporated by reference herein. Further, this application is related to a U.S. patent application, Attorney Docket No. PU050212, entitled “METHOD FOR REDUCED SHEATH BEAM BENDER WIDTH AND VIDEO CORRECTION IN A CRT DISPLAY”, filed concurrently herewith, and incorporated by reference herein.

### FIELD OF THE INVENTION

The invention relates to a cathode ray tube (CRT) display having a single plane beam bender and video corrections.

### BACKGROUND OF THE INVENTION

The popularity of HDTV has prompted an increased demand for television sets capable of displaying HDTV images. Such demand has prompted an increase in demand for larger aspect ratio, true flat screen displays having a shallower depth, increased deflection angle and improved visual resolution performance.

The demand for shallow, flat screen displays has led to efforts to improve spot performance so that spot size and shape exhibit greater uniformity across the entire screen for improved visual resolution performance. To this end, most displays now make use of dynamic focus. Increasing the deflection angle also yields an improvement in spot performance in the central area of the screen because increasing the deflection angle results in a decreased gun-to-screen distance, hereinafter referred to as the “throw” distance. FIG. 1 illustrates the basic geometrical relationship between throw distance and deflection angle for a typical CRT. Increasing the deflection angle (A) reduces the throw distance, thus allowing for production of a shorter CRT and ultimately, a slimmer television set.

As the deflection angle increases, the throw distance decreases and spot size decreases in a non-linear relationship. The following formula mathematically approximates relationship between spot size and throw distance:

Spot Size≈B*Throw^{1.4} (Equation 1)

where the exponent 1.4 represents an approximation taking into consideration the effects of magnification and space charge effects over a useful range of beam current. The term B represents a system-related proportionality constant. Considering this relationship, for a tube having a diagonal dimension of 760 mm, increasing the deflection angle from 100 degrees to 120 degrees while decreasing the center throw distance, for example, from 413 mm to 313 mm yields a 32% reduction in spot size at the center of the screen.

Increasing the deflection angle in these displays gives rise to increases in obliquity, which is defined as the effect of a beam intercepting the screen at an oblique angle, thereby causing an elongation of the spot. The problem of obliquity becomes especially apparent in CRTs having a standard horizontal gun orientation, i.e., a CRT whose guns have a horizontal alignment along the major axis of the screen. As obliquity increases, a spot having a generally circular shape at the center of the screen becomes oblong or elongated as the spot moves toward edges of the screen. Based on this geometrical relationship, in a large aspect ratio screen, such as a 16×9 screen, the spot appears most elongated at the edges of the major axis and at the screen corners. The obliquity effect causes the spot size to grow. The following equation defines the spot size radius SS_{radial}:

SS_{radial}=SSₙₒᵣₘₐₗ/cos(A) (Equation 2)

where A represents deflection angle, as measured from Dc to De as shown in FIG. 1 and nominal spot size SSₙₒᵣₘₐₗ represents the spot size without obliquity.

In addition to the obliquity effect, yoke deflection effects in self-converging CRTs having a horizontal gun orientation can compromise spot shape uniformity. To achieve self-convergence, CRT's typically include a horizontal yoke that generates a pincushion shaped field and a vertical yoke that generates a barrel shaped field. These yoke fields cause the spot shape to become elongated. This elongation adds to the obliquity effect by further increasing spot distortion at the three-o'clock and nine o'clock positions (referred to as the “3/9” positions) and at corner positions on the screen.

Various attempts have been made to address spot distortion and obliquity. For example, U.S. Pat. No. 5,170,102 describes a CRT with a vertical electron gun orientation whose undeflected beams appear parallel to the short axis of the display screen. The deflection system described in this patent includes a signal generator for causing scanning of the display screen in a raster-scan fashion, thereby yielding a plurality of lines oriented along the short axis of the display screen. The deflection system also comprises a first set of coils for generating a substantially pincushion-shaped deflection field for deflecting the beams in the direction of the short axis of the display screen. A second set of coils generates a substantially barrel shaped deflection field for deflecting the beams in the direction in the long axis of the display screen. The deflection system's coils generally distort spots by elongating them vertically. This vertical elongation compensates for obliquity effects, thereby reducing spot distortion at the 3/9 and corner positions on the screen. The barrel shaped field required to achieve self convergence at 3/9 screen locations overcompensates for obliquity and vertically elongates the spot at the 3/9 and corner locations as shown in FIG. 10 of the U.S. Pat. No. 5,170,102. (In effect, the barrel shaped field overcompensates, thus making the spot shape at the 3/9 position and the screen corners a vertically oriented ellipse.) Orienting the electron guns along the vertical or minor axis will yield improvements in a self-converging system, but spot distortion remains problematic at the 3/9 positions and at the corner screen locations.

Another problem with current CRTs relates to the overall length of the CRT. As flat panel TVs become more popular, the overall depth of a CRT TV becomes a major negative factor on the sales floor. One approach is to increase the customer appeal by increasing the deflection angle of the CRT as described in sections herein. An alternate approach is to reduce the depth of the neck components that are part of the CRT, hence allowing a reduction in the depth of the CRT.

### SUMMARY OF THE INVENTION

These and other drawbacks and disadvantages of the prior art are addressed by the present invention, which is directed to a cathode ray tube (CRT) display having a single plane beam bender and video corrections.

According to an aspect of the present invention, there is provided a CRT display system. The CRT display system includes an electron gun assembly, a single plane sheath beam bender, and a digital processor. The electron gun assembly is configured to emit electron beams. The single plane sheath beam bender is configured to apply a deflection force to the electron beams. The digital processor is configured to receive and process an incoming video signal stream to provide signals there from to be delivered to individual cathodes of the electron gun assembly. The provided signals have a distortion applied thereto to effect a predetermined converged image. The applied distortion at least relates to a blue-bow convergence error.

According to another aspect of the present invention, there is provided a CRT display system. The CRT display system includes an electron gun assembly, a single plane sheath beam bender, an input source, a receiver, a converted, an image processing unit, and a sync processor. The electron gun assembly is configured to emit electron beams. The single plane sheath beam bender is configured to cause a deflection of the electron beams. The input source is configured to provide horizontal and vertical progressive sync signals and R,G,B analog signals. The receiver is configured to perform analog-to-digital conversion, video correction, and digital-to-analog conversion of the R,G,B analog signals to provide interlaced R,G,B analog signals, and to provide H and V interlaced sync signals based on the horizontal and vertical progressive sync signals and a timing associated with the interlaced R,G,B analog signals. The converter is configured to convert the interlaced R,G,B analog signals to signals in a second component analog format, using at least one matrix operation. The image processing unit is configured to convert the signals in the second component analog format to signals in a R,G,B format for input to the electron guns, using at least one matrix operation. The sync processor is configured to receive the H and V interlaced sync signals from the receiver and provide processed sync signals there from, the processed sync signals for providing a desired raster geometry, a desired electron beam convergence, and a desired electron beam spot shape during a scanning of the electron beams. The receiver is further configured to correct a blue-bow convergence error.

According to yet another aspect of the present invention, there is provided a CRT display system. The CRT display system includes an electron gun assembly, a single plane sheath beam bender, an input source, a transpose module, an image processing module, a format converter, a video correction module, and a digital-to-analog converter. The electron gun assembly has vertically aligned inline guns configured to emit electron beams. The single plane sheath beam bender is configured to cause a deflection of the electron beams. The input source is configured to provide digital component video signals. The transpose module is configured to transpose the digital component video signals to progressively vertically scanned digital component video signals. The image processing module is configured to process the progressively vertically scanned digital component video signals. The format converter is configured to convert the processed progressively vertically scanned digital component video signals to R,G,B progressively vertically scanned signals. The video correction module is configured to correct geometry and convergence errors in the R,G,B progressively vertically scanned signals and to convert the R,G,B progressively vertically scanned signals to interlaced vertically scanned R,G,B digital signals. The digital-to-analog converter is configured to convert the interlaced vertically scanned R,G,B digital signals to interlaced R,G,B analog signals. The convergence errors corrected by the video correction module include a blue-bow convergence error.

According to a further aspect of the present invention, there is provided a CRT display system. The CRT display system includes an electron gun assembly, an electronic deflection system, a transposition module, a video correction module, and one or more image processors. The electron gun assembly has vertically aligned inline guns configured to emit electron beams. The electronic deflection system has a single plane sheath beam bender configured to apply a deflection force to the electron beams. The transposition module is configured to transpose an incoming video signal using a transposition operation. The video correction module is configured to perform video correction of the incoming video signal including correcting for a blue-bow convergence error. The one or more image processors are configured to perform enhancement operations to improve perceived image quality in a displayed image corresponding to the incoming video signal.

These and other aspects, features and advantages of the present invention will become apparent from the following detailed description of exemplary embodiments, which is to be read in connection with the accompanying drawings.

### BRIEF DESCRIPTION OF THE DRAWINGS

The invention will now be described by way of example with reference to the accompanying figures of which:

FIG. 1 is a diagram depicting the basic geometrical relationship between the throw distance and deflection angle in a typical CRT;

FIG. 2 is a diagrammatic cross sectional view of a CRT according to an embodiment of the present principles;

FIG. 3 is a diagram of the screen of the CRT of FIG. 2 illustrating a mis-convergence pattern in accordance with the present principles;

FIG. 4 is a diagram depicting optimization of spot shape in accordance with the present principles;

FIG. 5 is a block diagram of a first illustrative embodiment of the associated signal processing and electronic drive system for driving the CRT of FIG. 2 in accordance with the present principles in accordance with the present principles;

FIG. 6 is a block diagram of a second illustrative embodiment of the associated signal processing and electronic drive system for driving the CRT of FIG. 2 in accordance with the present principles;

FIG. 7 is a block diagram of a third illustrative embodiment of the associated signal processing and electronic drive system in accordance with the present principles;

FIG. 8 is a block diagram of a modification of the CRT display system shown of FIG. 6;

FIG. 9 is a block diagram showing a second modification of the CRT display system of FIG. 6.

FIG. 10 is a diagram depicting a portion of a CRT display screen subject to image distortion;

FIG. 11 is a block diagram of a video correction system within the CRT display system of FIGS. 5-9; and

FIG. 12 is a characteristic graph for a polyphase filter within the video correction system of FIG. 11.

FIGS. 13A-C show sheath beam benders (SBBs) having different sets of permanent magnets in two, three, and four planes, respectively, in accordance with the prior art;

FIG. 14 shows a sheath beam bender (SBB) having only one set of permanent magnets in one plane in accordance with the present principles; and

FIG. 15 shows a sheath beam bender (SBB) on a funnel of a cathode ray tube (CRT) in accordance with the present principles.

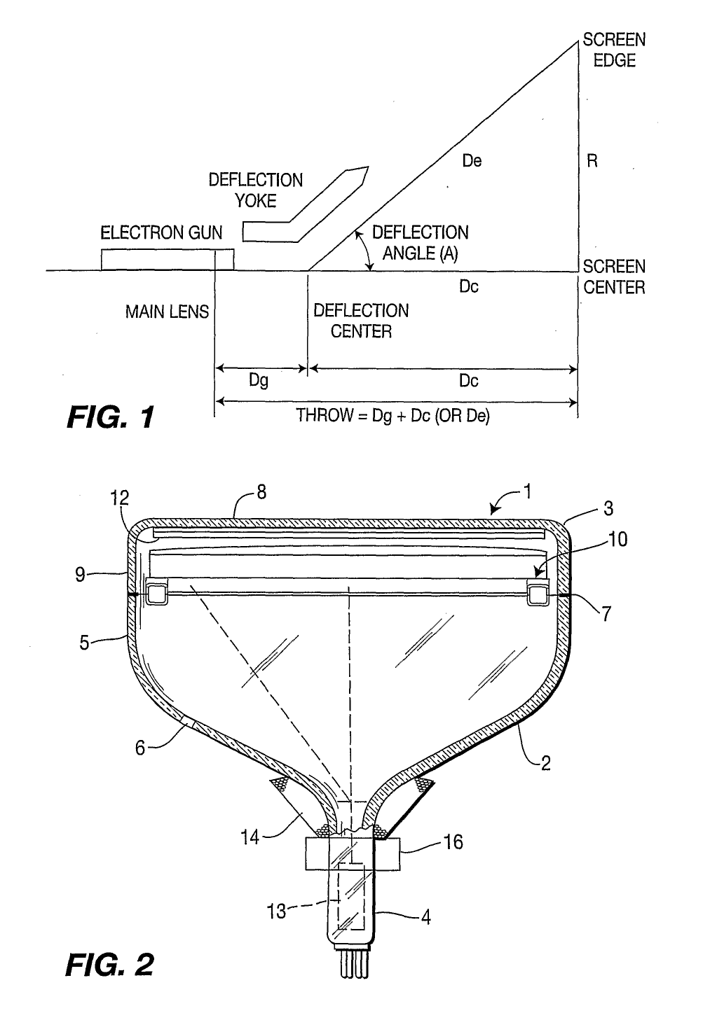

### DETAILED DESCRIPTION OF THE EMBODIMENTS

The present invention is directed to a cathode ray tube (CRT) display having a single plane sheath beam bender (SBB) and video corrections. The present invention may be used for analog or digital standard definition televisions and for High Definition Televisions (HDTVs). Moreover, the present invention may be used for televisions operating in a standard horizontal scan mode or a vertical scan mode.

The SBB in accordance with the present principles eliminates the multiple planes of prior-art devices. While such elimination also eliminates a capability of the SBB to correct for a typical convergence error known as blue-bow, the video correction capabilities of a CRT system in accordance with the present principles provide the means for correcting blue-bow convergence errors. Accordingly, an overall CRT system in accordance with the present principles provides a shorter length (i.e., shorter depth) system, while still correcting for blue-bow convergence errors. Moreover, another advantage is that a corresponding Yoke Adjustment Machine (YAM) process is simplified by eliminating the time-consuming blue-bow setup of the prior art SBB.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Prior to discussing the CRT display system of the present principles, a brief discussion of the facets of a typical cathode ray tube will prove helpful. FIG. 2 illustrates a cathode ray tube (CRT) 1, for example a W76 wide screen tube, having a glass envelope 2 comprising a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 comprises a viewing faceplate 8 and a peripheral flange or sidewall 9, which is sealed to the funnel 5 by a glass frit 7. The inner surface of the faceplate panel 3 carries a three-color phosphor screen 12. The screen 12 comprises a line screen with the phosphor lines arranged in triads. Each triad includes a phosphor line of three primary colors, typically Red, Green and Blue, and extends generally parallel to the major axis of the screen 12.

A mask assembly 10 lies in a predetermined spaced relation with the screen 12. The mask assembly 10 has a multiplicity of elongated slits extending generally parallel to the major axis of the screen 12. An electron gun assembly 13, shown schematically by dashed lines in FIG. 2, is centrally mounted within the neck 4 to generate three inline electron beams, a center beam and two side or outer beams, directed along convergent paths through the mask assembly 10 to strike the screen 12. The electron gun assembly 13 has three vertically oriented guns, each generating an electron beam for a separate one of the three colors, Red, Green and Blue. The three guns lie in a linear array extending parallel to a minor axis of the screen 12.

The CRT 1 employs an external magnetic deflection system comprised of a yoke 14 situated in the neighborhood of the funnel-to-neck junction. When activated with a drive signal in a manner discussed hereinafter, the yoke 14 generates magnetic fields that cause the beams to scan over the screen 12 vertically and horizontally in a rectangular raster. The external magnetic system or electronic deflection system can be driven by drive circuits and applies a high frequency deflection in a short direction to electron beams emitted from the electron guns of the electron gun assembly 13.

1. Electron Beam Spot Shaping and Convergence with Yoke Fields and Quadrupole Coils

A. Yoke Fields

In accordance with one aspect of the present principles, the electron beam undergoes spot shaping. To understand spot shaping, a discussion of the yoke 14 and the effect of the yoke fields will prove helpful. As discussed, the yoke 14 lies in the neighborhood of the funnel-to-neck junction on the CRT 1 as shown in FIG. 2. In the illustrated embodiment, the yoke 14 has first deflection coil system (not shown) that generates a horizontal deflection yoke field that is substantially barrel-shaped. The yoke 14 has a second deflection coil system (not shown) electrically insulated from the first deflection coil system for generating a vertical yoke field that is substantially pincushion-shaped. These yoke fields affect beam convergence and spot shape. Rather than adjust for self-convergence, the horizontal barrel field shape associated with the first deflection system undergoes an adjustment (e.g., a reduction), to yield an optimized spot shape at the sides of the screen. The barrel shape of the yoke field attributable to the second deflection coil system undergoes a reduction. The combined effects of the barrel-shaped field and the dynamic astigmatism correction provided by the dynamic focus associated with the electron guns yields an optimized, nearly round spot shape at the 3/9 position and at the corner screen locations. The use of pincushion vertical field and a barrel horizontal field, where the barrel horizontal field is adjusted to improve spot shapes and allow some misconvergence of the electron beams along the screen edges is characterized as quasi-self-convergent deflection fields.

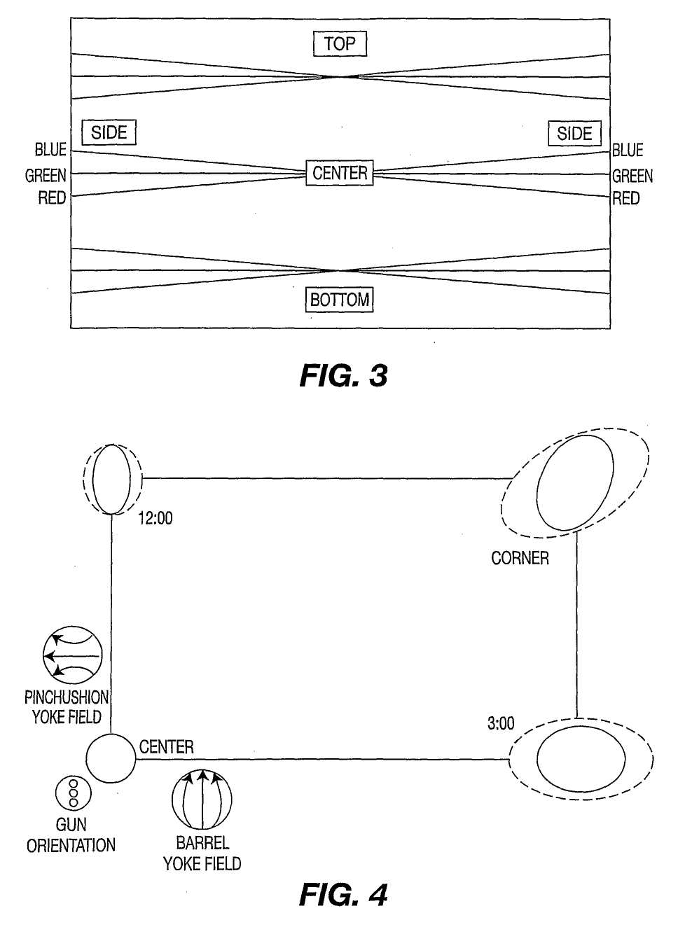

The field reduction that results in improved spot shape from self-convergence actually causes mis-convergence at certain locations on the screen. FIG. 3 illustrates a display screen showing the resulting misconvergence from such a reduced barrel-shaped field. For example, when the barrel field undergoes a reduction to achieve an optimized spot at the 3/9 positions and at the corner locations of the screen, the beams over-converge at the sides of the screen. Overconvergence as used here refers to a condition that results from the red and blue beams crossing over each other prior to striking the screen. The amount of overconvergence varies as a function beam deflection. Thus, the resultant pattern appears converged at the center of the screen while appearing mis-converged at the sides of the screen. Assuming the electron gun assembly 13 of FIG. 2 has its red, green, and guns orientated from top to bottom, the overconvergence causes the electron beams to generate a blue, green, red convergence pattern at the sides of the screen as seen in FIG. 3. The resultant overconvergence at the screen sides in this example was measured at 15 millimeters. Other CRT designs having different geometries or different yoke field distributions will result in more or less overconvergence, for example, in the range of 1 to 35 millimeters.

b. Multipole Coils

The addition of multipole coils, such as the quadrupole coils 16 shown in FIG. 2, can correct for mis-convergence, or over-convergence that results from the yoke effect described above. In particular, locating the quadrupole coils 16 on the gun side of the yoke 14 will dynamically correct for the yoke effect. The quadrupole coils 16 are fixed to the yoke 14 or alternatively, can be applied to the neck and have their four poles oriented at approximately 90° angles relative to each other as is known in the art. The adjacent poles of the coils 16 have alternating polarity and the orientation of their poles lies at 45° from the tube axes so that the resultant magnetic field displaces the outer (red and blue) beams in a vertical direction to provide correction for the mis-convergence pattern shown in FIG. 3. Alternatively, the quadrupole coils 16 can lie behind the yoke 14 approximately at or near the dynamic astigmatism correction point of the guns of the electron gun assembly 13.

Operating under dynamic control, the quadrupole coils 16 create a correction field for adjusting miscovergence on the screen. The quadrupole coils 16 in this embodiment are driven in synchronism with the horizontal deflection. The signal driving the quadrupole coils 16 has a magnitude selected to correct the overconvergence described above. In an illustrated embodiment, the quadrupole coil signal has a waveform whose shape approximates a parabola.

The electron gun assembly 13 of the CRT 1 has electrostatic dynamic focus astigmatism correction to achieve optimum focus in both the horizontal and vertical directions of each of the three beams. This electrostatic dynamic astigmatism correction occurs separately for each beam, thereby allowing for correction of the horizontal-to-vertical focus voltage differences without affecting convergence. Although the quadrupole coils 16 affect beam focus, their location near the dynamic astigmatism point of the guns of the electron gun assembly 13 allows for correction of this effect by adjusting the electrostatic dynamic astigmatism voltage so that there is a minimal effect on the spot. This enables correction of misconvergence at selected locations on the screen without affecting the spot shape. Advantageously, modification of the yoke field design can optimize spot shape and the dynamically driven quadrupole coils 16 can correct for any resultant misconvergence.

c. Yoke Field and Quadrupole Coils

FIG. 4 illustrates one quadrant of the screen of a W76 CRT with an aspect ratio of 16:9 and a 120° deflection angle and shows the improvement in spot shape and size obtained by the design of the yoke 14 and the use of the quadrupole coils 16 as discussed above. The spots illustrated by the dotted lines represent the effects of throw distance and obliquity referenced to a round center spot. Optimized spots obtained in accordance with the present principles appear with solid lines. Significant improvements in spot size and shape appear at the sides and corners of the screen. Table 1 lists experimental results for an illustrative embodiment in accordance with the present principles, with H representing the horizontal dimension of each spot, and V representing the vertical dimension of each spot normalized to the center spot. Table 1 compares the cumulative effect of gun orientation, yoke field effects and dynamically controlled quadrupole coils with dynamic astigmatism correction applied to traditional horizontal inline gun CRTs.

TABLE 1

| | Guns aligned horizontally | Guns aligned vertically |
|---|---|---|
| | 120 degree deflection | 120 degree deflection |
| | H × V normalized to | H × V normalized to |
| Spot Location | center | center |
| Bottom and Top | 1.1 × 1.5 | 0.8 × 1.6 |
| Sides | 3.0 × 0.6 | 2.0 × 1.5 |
| Corners | 3.0 × 0.9 | 1.6 × 2.0 |

The center column of Table 1 lists the spot dimensions for a prior art standard horizontal gun orientation CRT with self-convergent beams, whereas the right-hand column represents the results for a CRT with vertical gun alignment in accordance with the present principles wherein the beams undergo dynamically controlled convergence. Although spot shape suffers a slight compromise at the 6 O'clock and 12 O'clock screen positions (6/12 or otherwise as the top and bottom), spot size uniformity shows great improvement at the 3 O'clock and 9 O'clock positions (3/9 or otherwise as the side) and at the corner locations. The present technique advantageously provides more uniform spot shape across the screen, thus enhancing visual resolution. Although the invention is applicable to CRTs having deflection angles at 100 or above, the invention has particular applicability to much larger deflection angles such as systems exceeding 120 degrees.

### 2. Timing Considerations

Another facet of the CRT display system of the present principles involves the timing of the electron beam scanning in the CRT display. In this regard Table 2 provides a comparison of the clock frequency, scan line count, and pixel per scan line value for a conventional CRT having horizontal aligned electron guns versus a vertical scan CRT display in accordance with the present principles.

TABLE 2

| | Standard horizontal scan | | | | Vertical scan | |
|---|---|---|---|---|---|---|
| | HDTV1 | | HDTV2 | | HDTV | |
| Visual scan lines and pixels | | | | | | |
| Horizontal | 1920 | | 1280 | | 1280 | |
| Vertical | 1080 | | 720 | | 720 | |
| Refresh (field) rate | 60 | Hz | 60 | Hz | 60 | Hz |
| Interlace or progressive | Interlace | | Progressive | | Interlace | |
| Timing and circuit | | | | | | |
| considerations | | | | | | |
| Scan line direction | Horizontal | | Horizontal | | Vertical | |
| Total scan lines including | 1125 | | 750 | | 1375 | |
| retrace | | | | | | |
| Pixels per scan line inc. | 2475 | | 1650 | | 900 | |
| retrace | | | | | | |
| Scan frequency | 33.75 | kHz | 45 | kHz | 41.25 | kHz |
| Pixel clock rate | 83.5 | MHz | 74.25 | MHz | 37.125 | MHz |

The number of scan lines and pixel data listed in the Table 2 under the heading “Timing and circuit considerations” exceed the visual scan lines and pixel data, respectively, and take account of overscan and retrace. For the vertical gun alignment CRT in the Table 2, the visible image field contains 1280 vertical scan lines with 720 addressable points (i.e. 720 pixels/line) on each scan line.

The three different scan systems in Table 2 afford excellent visual performance. Any visual differences due to the number of scan lines or pixels appear insignificant on a screen size having a diagonal dimension of less than 1 meter at normal viewing distances of larger than 1 meter. The vertical scan system, however, provides a significantly better image because of the better spot size/resolution of the electron beam. While the high speed scan frequency remains about the same for all systems, the vertical scan system requires significantly less scan power because the deflection angle in the vertical direction is much smaller than horizontal direction for a 16×9 aspect ratio systems. Further, the pixel clock rate for the vertical scan system is much less than the other systems. A particularly advantageous arrangement utilizes 1280 interlaced visual scan lines, which significantly reduces the deflection power requirements with no detrimental effect when displaying HDTV images.

The CRT display system of the present principles can operate at scan rates other than those listed in Table 2. A scan rate that yields vertical scan lines in the range of approximately 700 to 3000 for 16:9 format tubes in the diagonal dimensional range between approximately 20 cm and 1 m provide excellent HDTV displays under normal home viewing conditions (approximately 2 meter viewing distance).

### 3. Video Processing System for Transposing and Adjusting Incoming Video Signal for Display

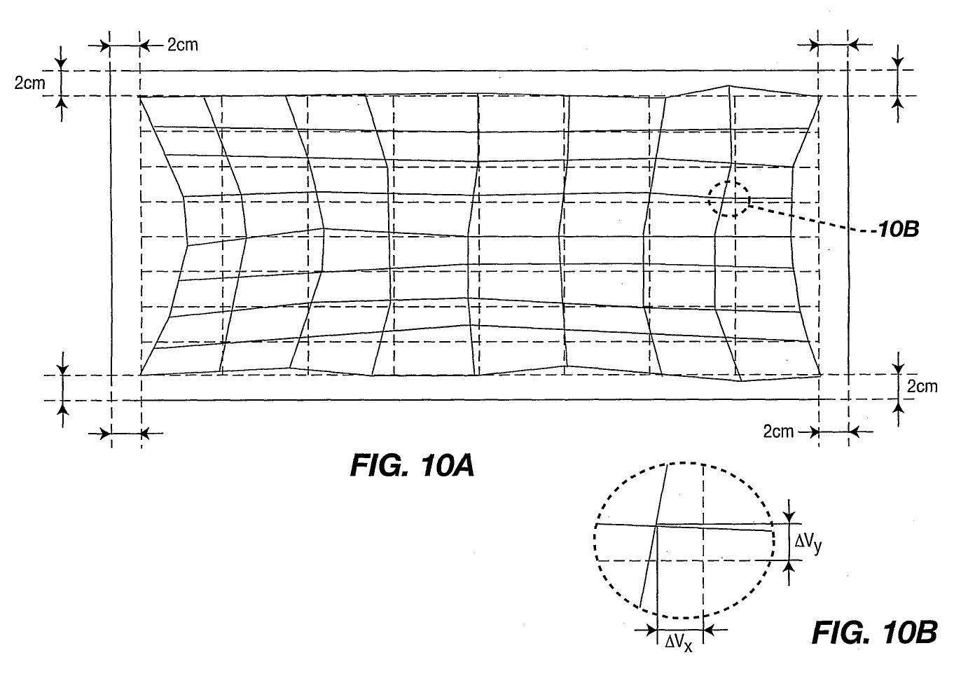

As described in greater detail with respect to FIGS. 10-12, the CRT display system of the present principles makes use of digital video correction that maps digital video signal information to the appropriate scan location to correct convergence and geometry. This video mapping does not affect the spot shape and affords an effective tool for achieving small corrections. For large corrections, video correction can cause some loss in light output since all the beams must scan all the areas of the screen for the video mapping to work. For example, employing video correction to compensate for the 15 mm of red-to-blue misconvergence shown in FIG. 3 typically would require an additional overscan of 7.5 mm at the top (for the red) and also at the bottom (for the blue) resulting in a light output loss of about 15/372 or 4% along the sides.

Employing video correction to yield improved convergence affords the possibility of eliminating multipole correction, by obviating the use of the quadrupole coils 16 of FIG. 2. Eliminating the quadrupole coils 16 will reduce the cost of the CRT display system. An alternative embodiment of the present principles makes use of both the quadrupole coils 16 and video correction to improve convergence.

Conventional video signal transmission assumes a pixel-by-pixel time sequence such that transmission of Red, Green and Blue images effectively occurs as a series of scan lines proceeding from the left edge to the right edge of the image along a scan line and then moving down to the next scan line where again the signal sequence proceeds from left to right. This process continues from top to bottom, in either a progressive scan mode or an interlaced scan mode, as is known in the art. To achieve a vertical scan display, the image must undergo a translation into a vertical scan pattern such that the signal sequence starts at the upper left hand corner of the image. The subsequent signal elements then follow along a vertical line from top to bottom along the left edge. After an appropriate blanking interval, generation of a signal element at the top edge of the image at the second scan line occurs, followed by the signal elements corresponding to a sequence from top to bottom along the second scan line. Similarly the third scan line starts at the top and proceeds to the bottom of the image, and thus the corresponding top to bottom signal element must be provided. This process continues through the last scan line at right vertical edge of the image.

To effect vertical scanning, a horizontal scan sequence must undergo a change from a conventional left-to-right and stepwise top-to-bottom regimen to a top-to-bottom and stepwise left to right transposed sequence. For the purposes of the following discussion, the terms “Digital Orthogonal Scan” or DOS refer to the above-described transposition operation.

In general, CRT displays exhibit raster distortions. The commonest raster distortions pertain to geometric errors and to convergence errors. A geometric error results from non-linearities in the scanned positions of the beams as the raster traverses the screen. Convergence errors occur in a CRT display when the Red, Green and Blue rasters do not align perfectly such that over some portion of the image, a Red sub-image appears offset with respect to the Green sub-image and the Blue sub-image appears offset to the right of the Green sub-image. Convergence errors of this type can occur in any direction and can appear anywhere in the displayed image.

With known color CRT displays, both convergence and geometric errors occur despite perfect alignment of the center region during the original manufacture of the CRT display, assuming that the deflection signals applied to the deflection coils ramp linearly. Traditional, analog circuit techniques compensate for such distortions by modifying the deflection signals from linear ramps to more complex wave shapes. Also, adjustment in the details of the yoke design can reduce convergence errors and geometry errors. As the deflection angle increases beyond 100°, traditional methods of geometry and convergence corrections become more difficult to implement.

The basic idea of Video Correction (VC) relies on the assumption that the CRT causes geometry and/or convergence distortion of the incoming image. If prior to display, the incoming signal undergoes processing in a manner to actually distort the signal inverse to the distortion inherent in the CRT, then the signal, when displayed, will appear distortion-free. With reference to the example given above for convergence errors, VC performs inverse distortion by displacing the Red sub-image in the opposite direction (e.g., to the right) by the same amount with respect to the Green sub-image to counteract the CRT distortion which effectively displaces the Red Sub-image to the left and similarly displaces the Blue sub-image to the left, resulting in good Red-to-Green convergence. Similarly, the VC displaces the Blue sub-image to the left, compensating for the CRT convergence distortion. It should be appreciated that VC can also be used to reshape all sub-images (including the Green sub-image) to reshape the entire overall raster geometry. Further, VC can be used in conjunction with the yoke field to achieved desired raster geometries.

Prior art optimized CRT display systems commonly employ Image Processing (IP) techniques which cause the displayed image, as seen by the human eye, to appear superior to the same image in the absence of any processing. Edge enhancement constitutes a typical example of image processing, and serves to enhance brightness transition gradients so that the image appears sharper.

The foregoing DOS and VC operations according to the invention herein described are preferentially executed in the digital domain. IP operations can be executed in analog or digital forms. The digital form for IP is preferred when digital signals are available in the signal path. The various signal processing tasks associated with DOS, VC and IP operations can be effectively executed in a programmable gate array and associated memory. The programmable gate array can take several alternative forms including field programmable gate arrays (which are commonly referred to as FPGAs), mask programmable gate arrays, and Application-specific Integrated Circuits and other forms of circuits suitable for digital signal processing.

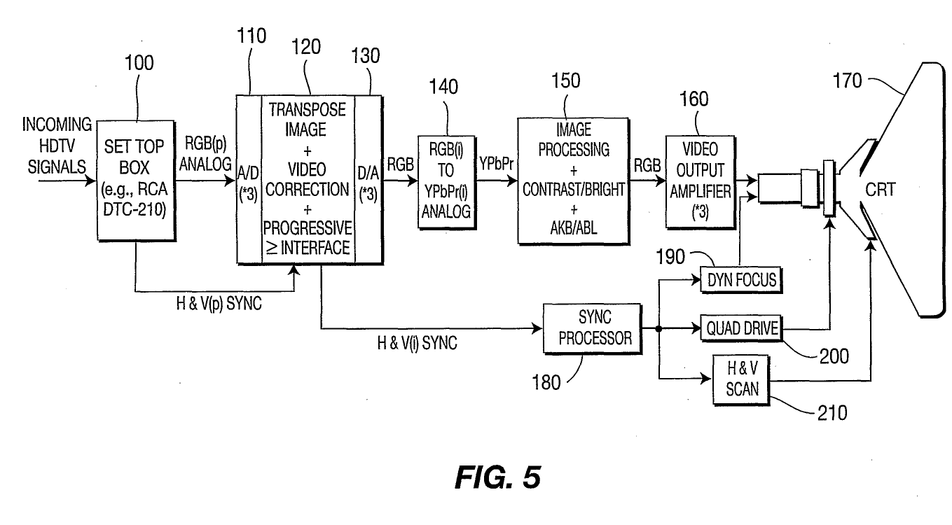

FIGS. 5, 6, and 7 illustrate alternate embodiments of a vertical-scan CRT display system that performs a combination of DOS, VC, and IP operations in accordance with the present principles. As will become better understood, some embodiments perform one or more of the DOS, VC, and IP operations in the digital domain while other embodiments perform one or more operations in the analog domain.

FIG. 5 illustrates a first embodiment of a vertically transposed scan CRT display system in accordance with the present principles. The display system receives input signals from a source such as a Set-Top Box (STB) 100, for example, an RCA Model DTC 210 set top box. The STB 100 provides horizontal and vertical progressive sync [H&V(p)Sync] signals and Red, Green, and Blue analog signals [RGB(p)]. These signals undergo processing by a Digital Signal Processing (DSP) system that comprises elements 110, 120 and 130. Element 110 comprises an analog-to-digital (A/D) converter that converts the RGB(p) analog signals into three digital signal arrays for the R, G, and B progressive rasters, respectively.

Element 120 comprises firmware, typically in the form of a programmable gate array that operates on the RGB(p) signal set to perform VC operations described in greater detail with respect to FIGS. 10-12. Alternatively, the element 120 could take the form of a programmed processor. The individually corrected R, G, and B arrays typically undergo storage in a memory (not shown) comprising part of the gate array 120. The memory reads out individual R, G and B signals as transposed vertical scan signal (DOS) in an interlaced manner. Thus, the output of the gate array 120 comprises a set of interlaced digital R, G, and B signals. Furthermore, the gate array also provides H and V interlaced sync signals corresponding to the timing associated with the transposed, vertically scanned, interlaced signal format.

Element 130 in FIG. 5 comprises a digital-to-analog (D/A) converter for converting the R, G, and B signals into corresponding interlaced analog R, G, and B signals, respectively. Element 140 comprises a matrix operator that converts the R, G, and B signals into a YPbPr format through standard matrix operations. Alternatively, the matrix operator 140 could convert the R, G, and B signals to other formats such as YUV or YCbCr. Thus, the term “YPbPr format” includes any type of component signal encoded into a luminance channel and two color difference channels in either digital or analog form. Similarly, luminance “RGB” as used herein, refers to the three color field components, whether in digital or analog form. When the formats (i.e. YPbPr, YCbCr, etc.) do not bear an explicit description as being digital or analog, the context will make clear the status of the signal.

An image processing unit 150 receives the DOS-modified component video from the matrix operator 140. The image processing element 150 performs image processing and optimization operations known in the art, such as edge enhancement. Further, the image processing element 150 possesses the ability to convert the YPbPr format signals back to an RGB format to adjust CRT parameters such as contrast, brightness, Automatic Kine Bias (AKB), and Automatic Beam Limit (ABL). Each of the R, G, and B signals from the image processing element 150 passes to a separate one of a set of video output amplifiers 160 that provides the input signals to the electron gun assembly of the CRT 170. The sync signals produced by the gate array 120 undergo further processing by sync processor 180 prior to input to the dynamic focus element 190 to generate a dynamic focus signal. A quad drive circuit 200 receives the processed sync signals from the sync processor 180 to generate the CRT deflection yoke signals. A deflection signal generator 210 processes the sync signals from the sync processor 180 to generate the H and V signals that drive the deflection coils of CRT 170.

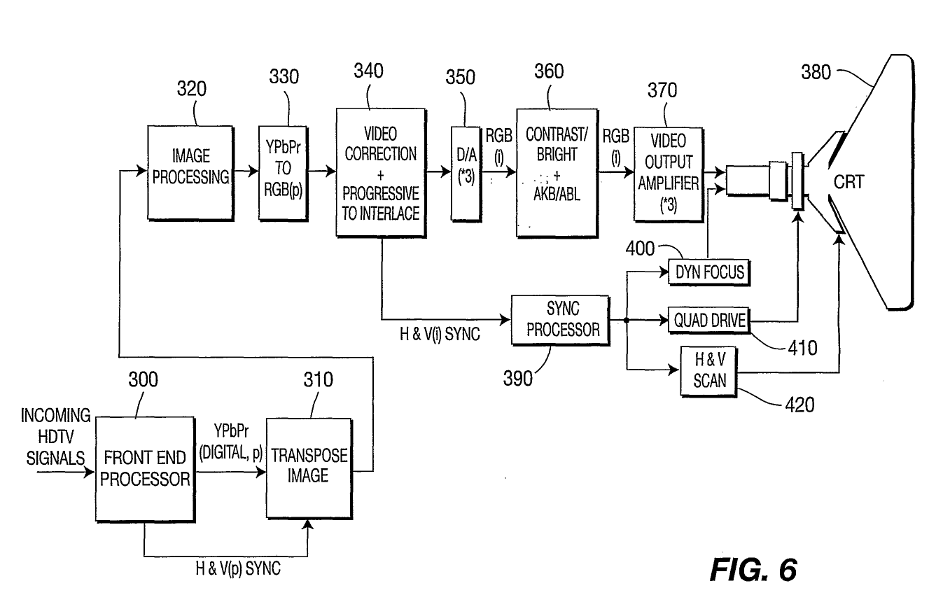

FIG. 6 shows an alternative embodiment of a vertical scan CRT display system in accordance with the present principles. A front-end processor element 300 receives incoming HDTV signals and provides a digital video output signal in a progressive scan YPbPr format, The front-end processor 300 also generates horizontal and vertical progressive sync. A transpose operator element 310 receives the output signals from the front-end processor and performs a DOS operation to yield a progressive vertically scanned YPbPr signal. An image processor 320 performs image processing on the vertically scanned YPbPr signal. For example, the image processor 320 can perform a basic set of IP functions, such as edge enhancement. A format converter 330 performs YPbPr to RGB format conversion to enable a video correction element 340 to accomplish Video Correction (VC). The video correction element 340 also accomplishes a conversion from progressive to interlaced vertical scanning. The digital RGB(i) interlaced vertical scan signal output by the video correction element 340 undergoes a conversion by a digital-to-analog (D/A) converter 350 yielding analog RGB(i) signals. An image processor 360 accomplishes final generation of the interlaced vertical scan signal by providing contrast, brightness, AKB, and ABL functions.

A video amplifier element 370 drives the three electron guns of CRT 380 in accordance with the RGB(i) signals from the image processor 360. A sync processor 390 provides sync signals to the dynamic focus generator 400, quad drive 410, and deflection signal generator 420 in accordance with the H&V(i) signals received by the sync processor from the video correction element 340.

While the CRT display systems of FIGS. 5 and 6 share common elements, they differ in several ways. Note that the CRT display system of FIG. 5 completes all IP operations after the DOS function and after the incoming signal has undergone Video Correction. The CRT display system of FIG. 6 performs the DOS function followed by Image Processing (IP). Such an arrangement allows for use of an image processor, such as image processor 320, designed to process the DOS signal prior to the VC operation which is especially desirable when VC is utilized for large convergence errors.

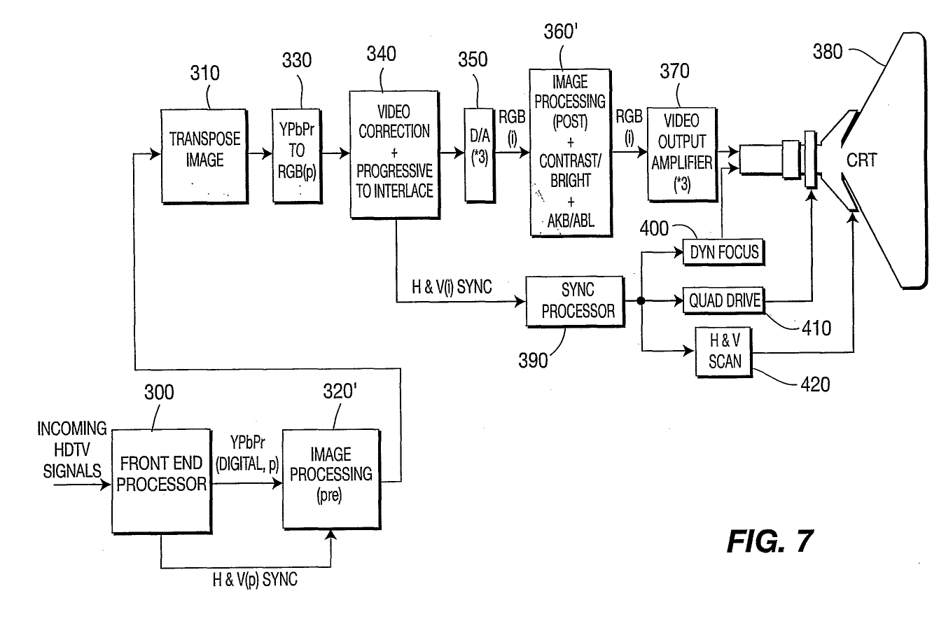

FIG. 7 depicts yet another embodiment of a CRT display system in accordance with the present principles. The CRT display system of FIG. 7 includes elements in common with the CRT display system of FIG. 6 and like reference numbers reference like elements. As discussed above, the CRT display system of FIG. 6 utilizes a single image processor 320 downstream of the transpose operator element 310. By comparison, the CRT display system of FIG. 7 employs two image processors 320′ and 360′. As seen in FIG. 7, the first image processor 320′ lies downstream of the front end processor 300 and provides pre-processing of the digital YPbPr signals prior to input to the image transpose operator element 310. The second image processor 360′ lies downstream of the D/A converter 350 and provides post processing of the interlaced analog RGB(i), as well as setting the brightness, AKB, and ABL. In all other respects, the CRT display system of FIG. 7 operates the same as that of FIG. 6.

An advantage can arise by doing some image pre-processing prior to preparing the signals for the specific addressing requirements associated with a particular display. Within the CRT display system of FIG. 7, the first image processor 320′ performs such pre-processing prior the DOS operation by the transpose operator element 310. Alternatively, the CRT display system of FIG. 7 could include yet another image processor (not shown) residing downstream of the transpose operator element 310 and upstream of the format converter 330.

A particular type of image pre-processing of general interest involves the pre-processing of 50 Hz HDTV images for display on a CRT operated in the transposed vertical scan mode. To minimize flicker, 50 Hz interlaced images commonly undergo conversion into another format. Digital signal processing methods allow conversion from 50 Hz to 60 Hz. The utilization of a pre-processor for accomplishing 50 Hz to 60 Hz conversion would allow the CRT display system of the present principles to operate at 60 Hz worldwide irrespective of whether the incoming signal utilizes a frequency of 50 Hz or 60 Hz. Alternatively, 50 Hz signals often undergo conversion to 75 Hz to eliminate flicker. Such a conversion to 75 Hz could occur within the first image processor 320′ in FIG. 7 and the remainder of the display chain, beginning with transpose operator element 310, could operate in a 75 Hz. mode.

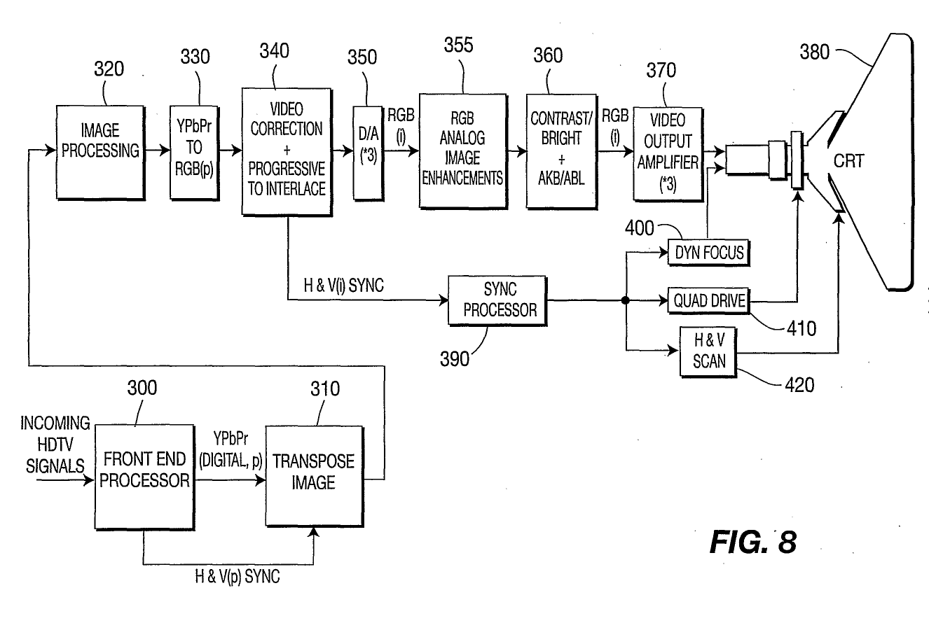

FIG. 8 illustrates yet another embodiment of a CRT display system that optimizes image quality. The CRT display system of FIG. 8 shares elements in common with the display system of FIGS. 6 and 7 and like reference numerals refer to like elements. As described hereinafter, the CRT display system of FIG. 8 executes a series of image enhancement Operations on the final RGB sub-images prior to display on the CRT 380. Common operations of this kind include peaking and edge enhancement by individual colors. The CRT display system of FIG. 8 accomplishes such enhancement by way of image enhancement element 355 situated downstream of the D/A converter 350 and upstream of the image processor 360. By virtue of being downstream from the D/A converter 350, the image enhancement element 355 accomplishes color-by-color post-processing in the analog domain. In other words, the enhancement element 355 and the image processor 360 can be characterized as a post-image processing element which sets contrast, brightness, AKB, and ABL and modifies RGB(i) analog signals, whereby at least one of the functions is performed from the group consisting of peaking, black stretch, color stretch and edge enhancement of individual colors.

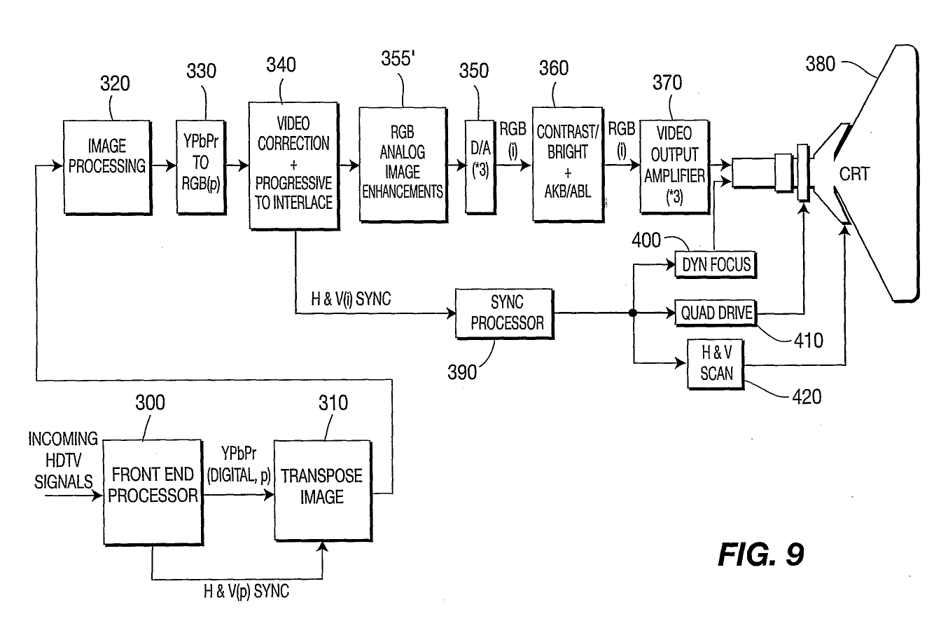

FIG. 9 depicts an alternative embodiment of a CRT display system, which like the CRT display system of FIG. 8, provides optimized image quality. The CRT display system of FIG. 9 employs many of the same elements as the display system of FIG. 8 and like numbers reference like elements. As compared to the CRT display system of FIG. 8 which performs color-by-color enhancements in the analog domain, the CRT display system of FIG. 9 performs such enhancements in the digital domain. To that end, the CRT display system of FIG. 9 employs a digital image enhancement element 355′ downstream of the Video Correction element 340 and upstream of the D/A converter 350. Thus, within the CRT display system of FIG. 9, the enhancement element 355′ accomplishes RGB image enhancements in the digital domain. Only after completion of the color by color image enhancements does digital-to-analog conversion take place.

The CRT display system of FIG. 9 can include the application of beam scan velocity modulation (BSVM) in the fast vertical scan direction. BSVM constitutes a sharpness enhancement method that involves local changes in the scan velocity of the electron beam based on brightness transitions in the video signal inputs. With reference to FIG. 9, either the video correction element 340 or the digital enhancement unit 355′ could provide a suitable BSVM signal.

In a generalized embodiment of the invention the CRT comprises a plurality of image processors to accomplish image enhancement operations to improve perceived image quality with respect to one or more attributes like edge sharpness, reduce noise, adjust color, and contrast in the displayed image. A first image processor receives an input signal and then feeds the signal to the transposition operation, and such first image processor may be an analog processor operating on an analog component YPbPr signal which, after processing, is fed to an analog-to-digital converter preceding the transposition operation, or such first processor could be a digital circuit operating on a digital component YCbCr signal, in which case first image processor input is either a component digital signal or a component analog signal which is then passed through an analog-to-digital converter which precedes first image processor. A second image processor following the digital transposition operation and preceding the video correction operation is utilized to cause further image enhancements subsequent to the image transposition, such second image processor is implemented in digital circuitry and operates on a transposed component video stream like YCbCr and such second image processor output is fed to a digital matrixing means which converts the digital component YCbCr signal to a digital RGB signal, which then is operated on by the video correction system. Further, a third image processor may be utilized and such third image processor is located in the signal stream subsequent to the video correction operation and such third image processor executes image enhancement operations on the individual RGB transposed and video corrected color signals; such third image processor may be of an analog type, in which case the digital RGB outputs are first converted by a digital-to-analog converter to analog RGB signals, or it may be of a digital type, in which case the digital RGB signals are directly fed to such third image processor and the output of this third image processor is then fed to a digital-to-analog converter whose RGB analog output is then available as input to the final elements in the video chain that drive the CRT and provide the appropriate signal levels to obtain optimized brightness, contrast, beam cut-off, and black level. Appropriate horizontal and vertical sync signals associated with the transposed and appropriately scanned image can be generated, and such sync signals provide input to a sync processor, which in turn provides appropriate inputs for sub-systems associated with the focusing, scanning, and other functions required for the operation and performance optimization functions of the vertically scanned CRT.

As discussed above, the CRT display systems of FIGS. 5-9 include video correction performed by the gate array element 120 of FIG. 5 and by the video correction element 340 of FIGS. 6-9. In accordance with the present principles, the video correction occurs by first determining the geometric raster distortion of each color, and then establishing the necessary horizontal and vertical displacement (i.e., Δx and Δy) needed to correct the individual raster distortions. The video then undergoes displacement by Δx and Δy to correct for such distortions.

To better understand the process by which such video correction occurs, refer to FIG. 10, which depicts an example of image distortion appearing on a CRT screen. Within the encircled area, the image appears distorted by the amounts Δx and Δy (shown as ΔVx and ΔVy in the FIG. 10). Note that the distortion over the image is not homogeneous and differs for each color.

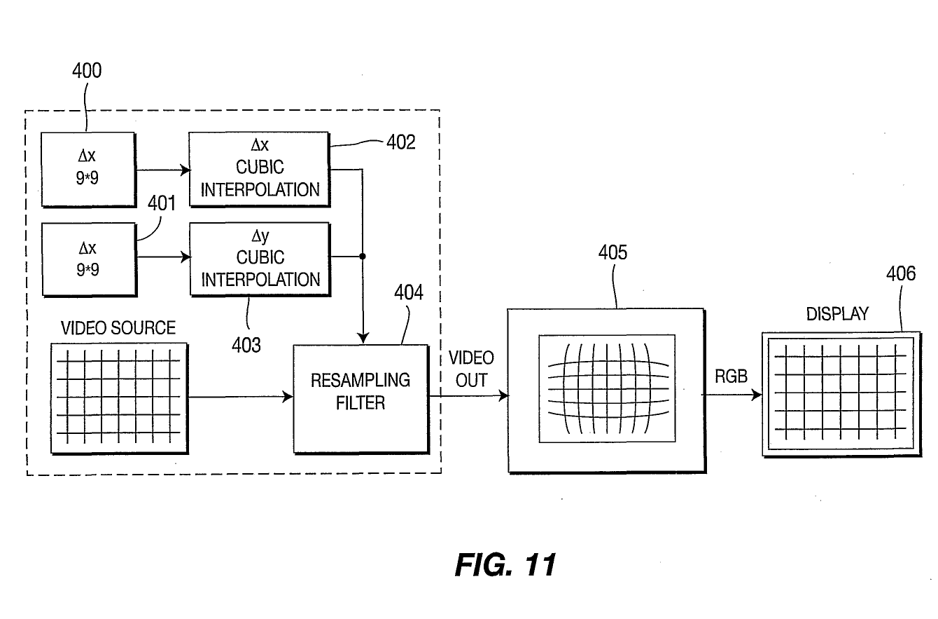

FIG. 11 provides a general overview of video correction for distortion in accordance with the present principles. First, a measuring device (not shown) determines the x and y offsets (Δx and Δy), typically with a grid of 9×9 or a 5×5 points spaced over the entire image, yielding Δx and Δy offset matrices 400 and 401. The Δx and Δy offset matrices undergo interpolation, via elements 402 and 403 in FIG. 11. In practice, the elements 402 and 403 can take the form of a programmed processor, application specific integrated circuit, field programmable gate array or digital signal process as an example. A re-sampling filter 404 re-samples video from an incoming source, such as the progressive RGB(p) signals from the format converter 330 of FIGS. 6-9 or the A/D converter 110 of FIG. 5 to yield a video image 405 that is distorted by an amount inverse to the distortion that arises from the geometric raster distortion of each color. Thus, the distortion created by video correction cancels the original distortion, yielding a substantially distortion free-image 406. As discussed, the horizontal Δx and vertical Δy displacements are measured or computed on a 9×9 grid. Interpolation of Δx and Δy samples becomes necessary to know the displacement at each point of the re-sampled image typically by the well known two dimensional cubic interpolation.

The result of the interpolation is a distortion vector comprising integer and non-integer components in both the x and y direction. The re-sampling filter 404 consists of a simple remapping of the pixels for the integer component of the distortion vector and of a polyphase filter for the non-integer component. The remapping is conveniently accomplished by reading out a video source memory with adjusted addresses, whereas the integer part of the above interpolation, typically cubic interpolation, is used for the address adjustment.

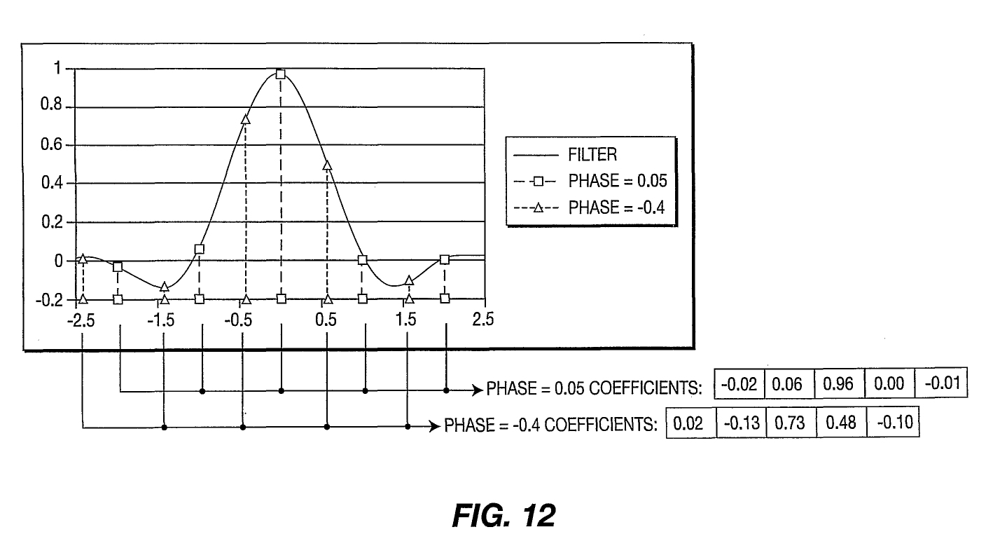

For performing the non-integer component of the re-sampling operation, filter 404 of FIG. 11 can take the form of a five tap polyphase filter as described in graph of FIG. 12. The graph of FIG. 12 shows coefficient values on its y-axis and tap values on its x-axis. The polyphase filter adapts its coefficients to the non-integer shift between the original and the final pixels. The non-integer component of the interpolation can assume values between −0.5 and +0.5, corresponding to interpolated pixel positions +/−0.5 sample spaces from the closest integer value. In FIG. 12 the computed five tap-weights are shown for two non-integer interpolated pixels. The non-integer components computed from the interpolation, shown here are +0.05 and −0.4 pixels from the closest integer position, these are referred to as Phase=0.05 and Phase=−0.4 in FIG. 12 respectively. The five element tables associated with each indicated Phase gives the weights for the filter tap summations, indicated in FIG. 12 as coefficients. Typically look-up tables are used to store the coefficients for a finite number of non-integer interpolated values. A common approach is to store the coefficients for 64 discreet phases and select the phase closest to the interpolated value.

Regarding the physical dimensions of the various parts, it is known to mount a sleeve—that includes a magnetic material such as strontium-ferrite onto a neck of a CRT for correcting static convergence, color purity and geometry errors in the CRT. A manufacturer of the magnetic material could extrude a heated magnetic material through a rectangular slit die, roll the material into sheets which are then cut into strips, or extrude the material in long tubes which are then cut into short cylinders. In the first two cases, long coils of belt-like sheath material are provided to the manufacturer, which are then cut into short strips of a desired length. The edges of a given strip are spliced, using a securing tape, to form a spliced cylindrical shape that is mounted on a funnel of the CRT to form a sleeve or sheath. In the third case, the material is provided to the manufacturer as short cylinders one of which is then mounted on a funnel of the CRT as a sleeve or sheath. This sleeve or sheath is known as a sheath beam bender. In all cases, the sheath beam bender could be mounted on a carrier that would then be mounted on the funnel.

Beam landing correction is accomplished by the creation of various combinations of magnetic poles in the magnetic material that produce static or permanent magnetic fields in the sheath beam bender. The magnetic fields vary the beam landing location in the CRT. The sheath beam bender can correct for mount seal rotation in the CRT, among other factors. A magnetizer head is used at the factory for magnetizing the sheath beam bender. Traditionally, a magnetizer head, not shown, is placed in the factory close to an exterior surface of a sheath beam bender to create various planes of two, four and six magnetic pole groups. The various combinations of magnetic poles in the magnetic material of the sheath beam bender vary the beam path within the CRT to provide convergence correction and vertical and horizontal location corrections to the electron beams, not shown, of the CRT.

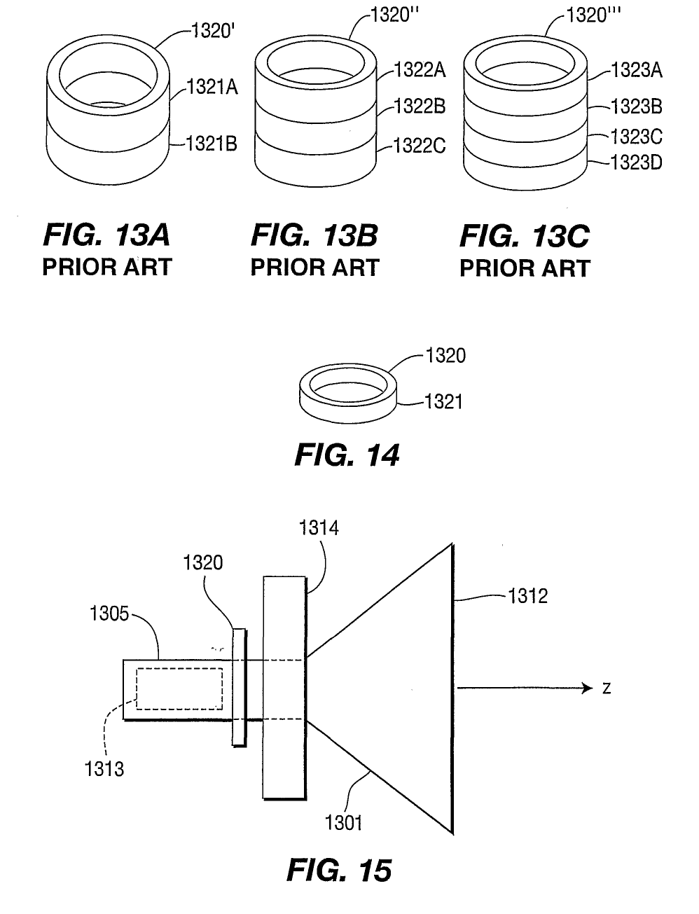

The sheath beam bender can be used to create two, four and six pole vertical and horizontal corrections to the electron beams at different planes perpendicular to the electron beam path. For example, one correction called Blue Bow and is generated by two pairs of physically separated four pole vertical corrections. FIGS. 13A-C shows sheath beam benders (SBB) having different sets of permanent magnets in two planes, three planes, and four planes, respectively, in accordance with the prior art. For example, FIG. 13A shows a sheath beam bender 1320′ having different sets of permanent magnets in two planes 1321A and 1321B, FIG. 13B shows a sheath beam bender 1320″ having different sets of permanent magnets in three planes 1322A, 1322B, and 1322C, and FIG. 13C shows a sheath beam bender 1320′″ having different sets of permanent magnets in four planes 1323A, 1323B, 1323C, and 1323D.

FIG. 14 shows a sheath beam bender (SBB) 1320 having only one set of permanent magnets in one plane 1321, in accordance with the present principles. With this single plane sheath beam bender 1320, Blue Bow correction capability disappears. However, video correction alone, or in combination with the system controls, corrects convergence errors that would have otherwise been possible with the sheath beam benders 1320′, 1320″, and/or 1320′″ of the prior art with a physical separation of the two or more planes of magnetization.

FIG. 15 shows the sheath beam bender 1320 on a funnel 1305 of a cathode ray tube (CRT) 1301, in accordance with the present principles. It is to be appreciated that FIG. 15 illustrates one exemplary way how the sheath beam bender 1320 can be positioned behind a deflection yoke 1314 after the deflection yoke 1314 is mounted on the funnel 1305.

It should be noted that in an embodiment, the sheath beam bender according to the present principles may be used along with an auxiliary Beam Scan Velocity Modulation (BSVM) coil, which is not shown in FIG. 15. Moreover, in an embodiment, the sheath beam bender 1320 may first be mounted on a carrier with the BSVM as part of an integrated assembly. Further, this carrier could be the deflection device itself.

It should also be noted that in conventional CRTs the sheath beam bender unit typically has a width of about 24 mm. However, with the sheath beam bender 1320 according to the present principles, the sheath beam bender 1320 is now between 4 and 12 mm, which results in a shortening of the space needed by the CRT neck components. As such, the invention provides a way of allowing a CRT designer to reduce the depth of the CRT by about 16 mm in the case where the SBB is 8 mm. This invention is particularly useful in CRTs with increased deflection angles (e.g., 118 degrees or greater). Further, an embodiment includes incorporating the sheath beam bender 1320 in CRTs having vertically scanned electron beams (i.e., the inline electron guns aligned vertically and the luminescent line of the screen oriented horizontally).

An additional advantage to using the sheath beam bender according to the present principles is that it eliminates the time to accomplish Blue Bow setup in the CRT manufacturing locations. That is, a corresponding Yoke Adjustment Machine (YAM) process is simplified by eliminating the time-consuming blue-bow setup of the prior art SBB.

While the foregoing describes sheath beam bender and a High Definition Television (HDTV) CRT display primarily operating in a vertical scan mode it should be understood that these principles may be applied to other types of CRTs and that the foregoing only illustrates some of the possibilities for practicing the invention. For example, the invention is applicable to a 16:9 screen aspect ratio, but can be applied to systems having a wide variety of aspect ratios like 4:3 or even higher than 16:9, such as 2:1. Moreover, the present invention may be applied to both analog or digital standard definition televisions. Many other embodiments are possible within the scope and spirit of the invention. It is, therefore, intended that the foregoing description be regarded as illustrative rather than limiting, and that the scope of the invention is given by the appended claims together with their full range of equivalents.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. The various processes and functions described herein may be either part of the microinstruction code or part of an application program, or any combination thereof, which may be executed by a CPU.

It is to be further understood that, because some of the constituent system components and methods depicted in the accompanying drawings may be implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A CRT display system, comprising:
an electron gun assembly configured to emit electron beams;
a single plane sheath beam bender configured to apply a deflection force to the electron beams; and
a digital processor for processing an incoming video signal stream to provide signals to individual cathodes of the electron gun assembly, the signals being distorted to cause an image; the applied distortion relating to a blue-bow convergence error.

2. The CRT display system of claim 1, wherein the single plane sheath beam bender is incapable of correcting the blue-bow convergence error due to a reduced overall plane count, and wherein said digital processor is configured to process the incoming signal to correct for the blue-bow convergence error by the applied distortion.

3. The CRT display system of claim 1, wherein the single plane sheath beam bender comprises a single plane of magnetic poles.

4. The CRT display system of claim 1, wherein the single plane sheath beam bender has only 8 poles.

5. The CRT display system of claim 1, wherein the single plane sheath beam bender has a width within the range of 4-12 mm.

6. The CRT display system of claim 1, further comprising an auxiliary Beam Scan Velocity Modulation coil.

7. The CRT display system of claim 6, wherein the single plane sheath beam bender is comprised together with the auxiliary Beam Scan Velocity Modulation coil.

8. The CRT display system of claim 7, wherein the CRT display system further comprises a cathode ray tube having a funnel, and the single plane sheath beam bender or the single plane sheath beam bender and the auxiliary Beam Scan Velocity Modulation coil are disposed on a carrier that, in turn, is mounted on the funnel.

9. The CRT display system of claim 1, wherein the electron gun assembly comprises vertically aligned inline guns configured to emit the electron beams, said digital processor is further configured to transpose a corresponding video image format of the incoming signal from a standard horizontal scheme to a vertical scheme, and the CRT display system further comprises a deflection device for providing deflection forces to the electron beams in accordance with the vertical scheme.

10. The CRT display system of claim 1, wherein the applied distortion is further processed for effecting a predetermined raster shape.

11. The CRT display system of claim 1, further wherein said electronic deflection system further includes quadrupole coils configured to generate a correction field for correcting convergence errors.

12. A CRT display system, comprising:
an electron gun assembly configured to emit electron beams;
a single plane sheath beam bender configured to cause a deflection of the electron beams;
an input source configured to provide horizontal and vertical progressive sync signals and R,G,B analog signals;
a receiver configured to perform analog-to-digital conversion, video correction, and digital-to-analog conversion of the R,G,B analog signals to provide interlaced R,G,B analog signals, and to provide H and V interlaced sync signals based on the horizontal and vertical progressive sync signals and a timing associated with the interlaced R,G,B analog signals;
a converter configured to convert the interlaced R,G,B analog signals to signals in a second component analog format, using at least one matrix operation;
an image processing unit configured to convert the signals in the second component analog format to signals in a R,G,B format for input to the electron guns, using at least one matrix operation;
a sync processor configured to receive the H and V interlaced sync signals from the receiver and provide processed sync signals there from, the processed sync signals for providing a desired raster geometry, a desired electron beam convergence, and a desired electron beam spot shape during a scanning of the electron beams,
wherein said receiver is further configured to correct a blue-bow convergence error.

13. The CRT display system of claim 12, wherein the single plane sheath beam bender is incapable of correcting the blue-bow convergence error due to a reduced overall plane count, and wherein said receiver is configured to process the incoming signal to correct for the blue-bow convergence error.

14. The CRT display system of claim 12, wherein the single plane sheath beam bender comprises a single plane of magnetic poles.

15. The CRT display system of claim 12, wherein the single plane sheath beam bender has only 8 poles.

16. The CRT display system of claim 12, wherein the single plane sheath beam bender (has a width within the range of 4-12 mm.

17. The CRT display system of claim 12, further comprising an auxiliary Beam Scan Velocity Modulation coil.

18. The CRT display system of claim 17, wherein the single plane sheath beam bender is comprised together with the auxiliary Beam Scan Velocity Modulation coil.

19. The CRT display system of claim 18, wherein the CRT display system further comprises a cathode ray tube having a funnel, and the single plane sheath beam bender or the single plane sheath beam bender and the auxiliary Beam Scan Velocity Modulation coil are disposed on a carrier that, in turn, is mounted on the funnel.

20. The CRT display system of claim 12, wherein the electron gun assembly comprises vertically aligned inline guns configured to emit the electron beams, said receiver is further configured to transpose a corresponding video image format of the R,G,B analog signals from a standard horizontal scheme to a vertical scheme, and the CRT display system further comprises a deflection device for providing deflection forces to the electron beams in accordance with the vertical scheme.

21. The CRT display system of claim 12, wherein said second component analog format is a YPbPr or a YCbCr component video format.

22. The CRT display system of claim 12, further comprising quadrupole coils configured to provide the desired electron beam convergence.

23. The CRT display system of claim 12, wherein the input source is a Set-Top Box.

24. The CRT display system of claim 12, wherein the receiver includes a digital signal processing system comprising:
an analog-to-digital converter configured to convert the R,G,B analog signals to R,G,B digital signals;
a programmable gate array and associated memory configured to perform image transposition and the video correction of the R,G,B digital signals, to transpose and individually correct the R,G,B digital signals to provide transposed, vertically scanned, interlaced R,G,B digital signals, and to provide the H and V interlaced sync signals corresponding to the timing associated with the transposed, vertically scanned, interlaced R,G,B digital signals; and
a digital-to-analog converter configured to convert the transposed, vertically scanned, interlaced R,G,B digital signals to the interlaced R,G,B analog signals.

25. The CRT display system of claim 12, wherein the image processing unit is configured to perform at least one of edge enhancement, contrast and brightness enhancement, an Automatic Kine Bias (AKB) function and an Automatic Beam Limitator (ABL) function.

26. The CRT display system of claim 24, further comprising:
a dynamic focus module configured to receive the processed sync signals and to provide a dynamic focus signal there from to the electron gun;
a quad drive module configured to receive the processed sync signals and to provide deflection yoke signals there from that drive quad drive coils of the CRT; and
horizontal and vertical scan drives configured to receive the processed sync signals and to provide H and V drive signals there from that drive yoke deflection coils of the CRT.

27. The CRT display system of claim 24, wherein the programmable gate array and associated memory are executed in the form of a Field Programmable Gate Array or an Application Specific Integrated Circuit which is either directly integrated with memory, packaged-integrated with memory or configured to utilize external memory components for its associated memory.

28. A CRT display system, comprising:
an electron gun assembly having vertically aligned inline guns configured to emit electron beams;
a single plane sheath beam bender configured to cause a deflection of the electron beams;
an input source configured to provide digital component video signals;
a transpose module configured to transpose the digital component video signals to progressively vertically scanned digital component video signals;
an image processing module configured to process the progressively vertically scanned digital component video signals;
a format converter configured to convert the processed progressively vertically scanned digital component video signals to R,G,B progressively vertically scanned signals;
a video correction module configured to correct geometry and convergence errors in the R,G,B progressively vertically scanned signals and to convert the R,G,B progressively vertically scanned signals to interlaced vertically scanned R,G,B digital signals; and
a digital-to-analog converter configured to convert the interlaced vertically scanned R,G,B digital signals to interlaced R,G,B analog signals,
wherein the convergence errors corrected by the video correction module include a blue-bow convergence error.

29. The CRT display system of claim 28, wherein the single plane sheath beam bender is incapable of correcting the blue-bow convergence error due to a reduced overall plane count, and wherein said video correction module is configured to process the R,G,B progressively vertically scanned signals to correct for the blue-bow convergence error.

30. The CRT display system of claim 28, wherein the single plane sheath beam bender comprises a single plane of magnetic poles.

31. The CRT display system of claim 28, wherein the single plane sheath beam bender has only 8 poles.

32. The CRT display system of claim 28, wherein the single plane sheath beam bender has a width within the range of 4-12 mm.

33. The CRT display system of claim 28, further comprising an auxiliary Beam Scan Velocity Modulation coil.

34. The CRT display system of claim 33, wherein the single plane sheath beam bender is comprised together with the auxiliary Beam Scan Velocity Modulation coil.

35. The CRT display system of claim 34, wherein the CRT display system further comprises a cathode ray tube having a funnel, and the single plane sheath beam bender or the single plane sheath beam bender and the auxiliary Beam Scan Velocity Modulation coil are disposed on a carrier that, in turn, is mounted on the funnel.

36. The CRT display system of claim 28, wherein said input source is further configured to provide horizontal and vertical progressive or interlaced sync signals, said video correction module is further configured to process the horizontal and vertical progressive or interlaced sync signals to provide processed horizontal and vertical progressive sync signals corresponding to a timing of the interlaced vertically scanned R,G,B digital signals, and the CRT display system further comprises:
a contrast and brightness module configured to apply at least one of contrast, brightness, Automatic Kine Bias (AKB), and Automatic Beam Limitator (ABL) functions to the R,G,B analog signals;
a video amplifier configured to drive said electron gun assembly using the R,G,B analog signals; and
a sync processor configured to receive processed horizontal and vertical progressive sync signals from said video correction module and to provide further processed sync signals there from to a dynamic focus generator, a quadrupole drive, and deflection signal generator.

37. The CRT display system of claim 36, further comprising an image enhancement module disposed before said contrast and brightness module, said image enhancement module configured to execute a series of image enhancement operations on final RGB sub-images corresponding to the R,G,B analog signals prior to display, the image enhancement operations including at least one of peaking and edge enhancement by individual colors.

38. The CRT display system of claim 28, wherein said video correction module is further configured to provide H and V sync signals, and the CRT display system further comprises:
a post-image processing module configured to apply at least one of contrast, brightness, Automatic Kine Bias (AKB), and Automatic Beam Limitator (ABL) functions to the R,G,B analog signals, the functions including at least one of peaking, black stretch, color stretch and edge enhancement of individual colors;
a final video amplifier configured to drive said electron gun assembly using the R,G,B analog signals; and
a sync processor configured to process the H and V sync signals to provide processed H and V sync signals to a dynamic focus generator, a quad drive, and a deflection signal generator.

39. The CRT display system of claim 28, further comprising a digital enhancement module configured to perform R,G,B image enhancements in the digital domain to the interlaced vertically scanned R,G,B digital signals prior to analog conversion thereof by said digital-to-analog converter.

40. The CRT display system of claim 28, wherein said progressively vertically scanned digital component video signal is a YPbPr or YCbCr component video format.

41. The CRT display system of claim 28, further comprising a first image processor connected in signal communication with and preceding said transpose module, configured to provide pre-processing of the digital component video signals.

42. A CRT display system, comprising:
an electron gun assembly having vertically aligned inline guns configured to emit electron beams;
an electronic deflection system having a single plane sheath beam bender configured to apply a deflection force to the electron beams;
a transposition module configured to transpose an incoming video signal using a transposition operation;
a video correction module configured to perform video correction of the incoming video signal including correcting for a blue-bow convergence error; and
one or more image processors configured to perform enhancement operations to improve perceived image quality in a displayed image corresponding to the incoming video signal.

43. The CRT display system of claim 42, wherein the single plane sheath beam bender is incapable of correcting the blue-bow convergence error due to a reduced overall plane count, and wherein said video correction module is configured to process the incoming video signal to correct for the blue-bow convergence error.

44. The CRT display system of claim 42, wherein the single plane sheath beam bender comprises a single plane of magnetic poles.

45. The CRT display system of claim 42, wherein the single plane sheath beam bender has only 8 poles.

46. The CRT display system of claim 42, wherein the single plane sheath beam bender has a width within the range of 4-12 mm.

47. The CRT display system of claim 42, further comprising an auxiliary Beam Scan Velocity Modulation coil.

48. The CRT display system of claim 47, wherein the single plane sheath beam bender is comprised together with the auxiliary Beam Scan Velocity Modulation coil.

49. The CRT display system of claim 48, wherein the CRT display system further comprises a cathode ray tube having a funnel, and the single plane sheath beam bender or the single plane sheath beam bender and the auxiliary Beam Scan Velocity Modulation coil are disposed on a carrier that, in turn, is mounted on the funnel.

50. The CRT display system of claim 42, wherein the enhancement operations include at least one of edge sharpness, noise reduction, color adjustment, and contrast adjustment.

51. The CRT display system of claim 42, further comprising an analog-to-digital converter connected in signal communication with and preceding said transposition module, and wherein the one or more image processors includes a first image processor configured to process the incoming video signal and provide the processed incoming video signal to the analog-to-digital converter, wherein the first image processor is an analog processor, and the incoming video signal is an analog component YPbPr signal.

52. The CRT display system of claim 42, wherein the one or more image processors include a first image processor having a digital circuit configured to process a digital component YCbCr signal, and an input to said first image processor is either component digital signals or component analog signals, the component analog signals being processed by an analog-to-digital converter that precedes said first image processor.

53. The CRT display system of claim 52, wherein the one or more image processors include a second image processor, connected in signal communication with and subsequent to said transposition module and preceding said video correction module, configured to perform image enhancement, the second image processor being implemented in digital circuitry, the CRT display further comprising a digital matrix means configured to convert the component digital signals to R,G,B digital signals prior to outputting the R,G,B digital signals to said video correction module.

54. The CRT display system of claim 53, wherein the one or more image processors include a third image processor, disposed subsequent to the video correction module, the third image processor configured to execute image enhancement operations.

55. The CRT display system of claim 54, wherein the third image processor operates in an analog domain, and the CRT display system further comprises a digital-to-analog converter connected in signal communication with and prior to said third image processor and configured to convert the R,G,B digital signals output from said video correction module to RGB analog signals, the third image processor configured to execute the image enhancement operations on individual ones of the R,G,B digital signals output from said video correction module.

56. The CRT display system of claim 54, wherein the third image processor operates in a digital domain, and the CRT display system further comprises a digital-to-analog converter connected in signal communication with and subsequent to said third image processor to convert the R,G,B digital signals output from said third image processor to R,G,B analog signals.

57. The CRT display system of claim 55, wherein said video correction module is further configured to generate horizontal and vertical sync signals, and the CRT display system further comprises a sync processor configured to receive the horizontal and vertical sync signals and to provide processed horizontal and vertical sync signals there from.

58. The CRT display system of claim 51, wherein the one or more image processors include a second image processor, connected in signal communication with and subsequent to said transposition module and preceding said video correction module, configured to perform image enhancement, the second image processor being implemented in digital circuitry, the CRT display system further comprising a digital matrix means configured to convert the component digital signals to R,G,B digital signals prior to outputting the R,G,B digital signals to said video correction module.

59. The CRT display system of claim 58, wherein the one or more image processors include a third image processor, disposed subsequent to the video correction module, the third image processor configured to execute image enhancement operations.

60. The CRT display system of claim 59, wherein the third image processor operates in an analog domain, and the CRT display system further comprises a digital-to-analog converter connected in signal communication with and prior to said third image processor and configured to convert the R,G,B digital signals output from said video correction module to R,G,B analog signals, the third image processor configured to execute the image enhancement operations on individual ones of the R,G,B digital signals output from said video correction module.

61. The CRT display system of claim 59, wherein the third image processor operates in a digital domain, and the CRT display system further comprises a digital-to-analog converter connected in signal communication with and subsequent to said third image processor and configured to convert the R,G,B digital signals output from said third image processor to R,G,B analog signals.

62. The CRT display system of claim 60, wherein said video correction module is further configured to generate horizontal and vertical sync signals, and the CRT display system further comprises a sync processor configured to receive the horizontal and vertical sync signals and to provides appropriate inputs there from.
